(19) United States
(12) Patent Application Publication
(10) Pub. No.: US 2011/0220634 A1
(43) Pub. Date: Sep. 15, 2011

(54) Wirelessly-chargeable heating pad

(75) Inventor: Ming-Hsiang Yeh, Taipei City (TW)

(73) Assignee: Winharbor Technology Co., Ltd., New Taipei City (TW)

(21) Appl. No.: 13/064,003

(22) Filed: Mar. 2, 2011

(30) Foreign Application Priority Data
Mar. 12, 2010 (TW) 099204363

(51) Int. Cl. H05B 3/02

(52) U.S. Cl. 219/482

(57) ABSTRACT

The present invention provides a wirelessly-chargeable heating pad, which is coupled to an article in a removable manner and is used in combination with a charging device to perform wireless electrical charging. The wirelessly-chargeable heating pad includes a receiver circuit, a heating element, and a pad body. The receiver circuit includes a rechargeable battery. The heating element is electrically connected to the rechargeable battery. The heating element and the receiver circuit are both mounted to the pad body. The article includes a removable mounting structure, so that the wirelessly-chargeable heating pad is removably coupled to the article through the removable mounting structure. The charging device, after receiving electrical power, converts the electrical power into an alternate current signal that is transmitted to the receiver circuit. The receiver circuit receives and converts the alternate current signal into electrical power that is then stored in the rechargeable battery. The rechargeable battery subsequently supplies the electrical power to the heating element to give off heat.

### FIELD OF THE INVENTION

The present invention relates to a wirelessly-chargeable heating pad, and in particular to a wirelessly-chargeable heating pad that is wirelessly chargeable for giving off heat to realize temperature keeping and warm keeping and is applicable to garments, bed quilt, blanket, shoes, gloves, scarves, pillows, medical heating pads, hats, chair cushions, and mattresses.

### BACKGROUND OF THE INVENTION

In cold winters, one of the most commonly adopted ways for protecting oneself against the cold is to put on more clothes. However, the more clothes one puts on the body, the greater weight one must carry. This makes it difficult to take a movement or activity. For quilts and blankets that are often used to protect a user against the cold, heavy and thick quilts and blankets, although more effective in protection against the cold, may induce quite a pressure on the human body. This is a problem long troubling the users.

To overcome such a problem, it has been adopted to add a heating device to an article of garment, quilt, or blanket to realize temperature keeping and warm keeping. Examples include an electrical heating garment that comprises a heating device incorporated in the garment and an electrical heating blanket that comprises a heating device combined with a blanket.

However, such an article of electrical heating garment or electrical heating blanket must be supplied with or charged with electrical power through a wire or cable. In other words, a power cord must be connected to the article and this makes it inconvenient to charge or supply power to the article. Further, the conventional product of garment, quilt, and blanket that is combined with a heating device is not water washable, for water washing will damage the heating device and once the heating device is damaged, a new product must be acquired for replacement. This causes a waste and a problem of environmental pollution for the damaged articles are generally non-recyclable.

Thus, it is desired to provide an electrical heating device that is wirelessly chargeable, and is removably mountable for easy detachment.

### SUMMARY OF THE INVENTION

An objective of the present invention is to provide a wirelessly-chargeable heating pad, which is electrically chargeable through a non-contact wireless manner to ensure improved flexibility and convenience for electrical charging. The wirelessly-chargeable heating pad is mountable to an article of gloves, shoes, or clothes to realize temperature keeping, warm keeping, and dry keeping for a user wearing the article. Through a removable mounting structure, the wirelessly-chargeable heating pad is readily removable so that the removed wirelessly-chargeable heating pad shows the advantages of easy repairing and maintenance of the wirelessly-chargeable heating pad, allowing the article to be water-washed, being free of short-circuiting and malfunctioning the wirelessly-chargeable heating pad caused by water washing.

To achieve the above objective, the present invention provides a wirelessly-chargeable heating pad, which is mountable to an article and is used in combination with a charging device that comprises a transmitter circuit to realize wireless electrical charging. The transmitter circuit is connected to a power source so that the power source supplies electrical power to the transmitter circuit and the electrical power is converted by the transmitter circuit into an alternate current signal. The wirelessly-chargeable heating pad comprises a receiver circuit, a heating element, and a pad body. The receiver circuit comprises a rechargeable battery. The heating element is electrically connected to the rechargeable battery. The heating element and the receiver circuit are arranged in the pad body. The article comprises a removable mounting structure, whereby the heating element and the receiver circuit are removably mountable to the article through the removable mounting structure. The alternate current signal is transmitted from the transmitter circuit of the charging device to the receiver circuit and is received and converted by the receiver circuit into electrical power that is stored in the rechargeable battery to be subsequently supplied to the heating device.

As such, the wireless chargeability provides improved flexibility and convenience in performing electrical charging. When the wirelessly-chargeable heating pad is coupled to an article of gloves, shoes, or clothes, functions of temperature-keeping, warm-keeping, and dry-keeping can be realized for a user wearing the article. To remove or mount the wirelessly-chargeable heating pad, the removable mounting structure facilitates ready removal and mounting of the wirelessly-chargeable heating pad so that the following advantages: easy repairing and maintenance of the wirelessly-chargeable heating pad, allowing the article to be water-washed, being free of short-circuiting and malfunctioning the wirelessly-chargeable heating pad caused by water washing, can be achieved after the removal of the wirelessly-chargeable heating pad.

### BRIEF DESCRIPTION OF THE DRAWINGS

The present invention will be apparent to those skilled in the art by reading the following description of preferred embodiments thereof with reference to the drawings, in which:

FIG. 1A is a perspective view showing a wirelessly-chargeable heating pad according to the present invention, wherein the heating pad is received in a receptacle portion of an article;

FIG. 1B is a schematic view of the first embodiment of the present invention with the heating pad not received in the receptacle portion of the article;

FIG. 1C is a circuit diagram of the present invention;

FIG. 2A is a schematics view showing a second embodiment of the present invention with a heating pad not positioned on a body of a charging device;

FIG. 2B is a schematic view showing a different example of the second embodiment of the present invention, in which a charging device of different form is shown; and

FIG. 3 is a schematic view showing a third embodiment of the present invention.

### DETAILED DESCRIPTION OF THE PREFERRED EMBODIMENTS

The present invention provides a wirelessly-chargeable heating pad, wherein energy can be transmitted in a wireless fashion through an alternate current signal to be received by the wirelessly-chargeable heating pad for electrical charging. In practice, a user may readily remove the wirelessly-chargeable heating pad from an article (such as garments, bed quilt, blanket, shoes, gloves, scarves, pillows, medical heating pads, hats, chair cushions, and mattresses) to achieve the functions of temperature keeping and warm keeping through heat generated by the wirelessly-chargeable heating pad. The electrical charging is realized through non-contact wireless charging and is thus flexible and convenient. The wirelessly-chargeable heating pad can be removed from the article for easy maintenance and repairing. After the wirelessly-chargeable heating pad is removed, the article can be washed with water without any concern of short-circuiting and malfunctioning of the wirelessly-chargeable heating pad due to contact with water.

The wirelessly-chargeable heating pad 5, 5a, 5b is mountable to an article 1, 2, 3 and the wirelessly-chargeable heating pad 5, 5a, 5b is used in combination with a charging device 6, 6a, 6b, which comprises a transmitter circuit 61 for realizing wireless electrical charging. The transmitter circuit 61 is connected to a power source 62. The power source 22 supplies electrical power to the transmitter circuit 61 and the electrical power is converted by the transmitter circuit 61 into an alternate current signal to be received by a receiver circuit 51 of the wirelessly-chargeable heating pad 5, 5a, 5b for subsequent storage of the electrical power.

### First Embodiment

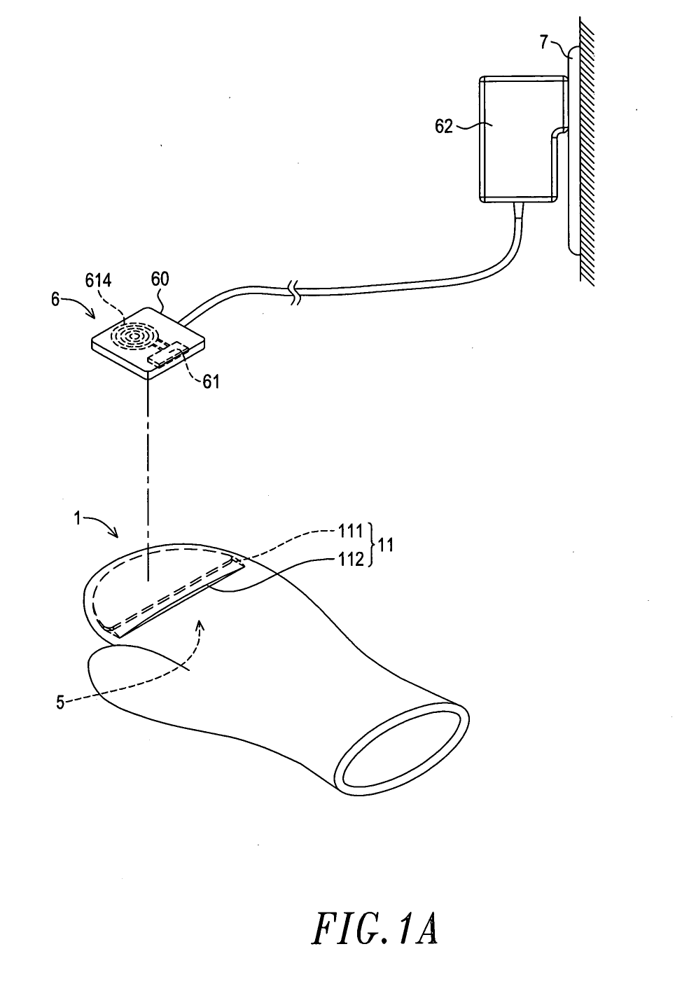

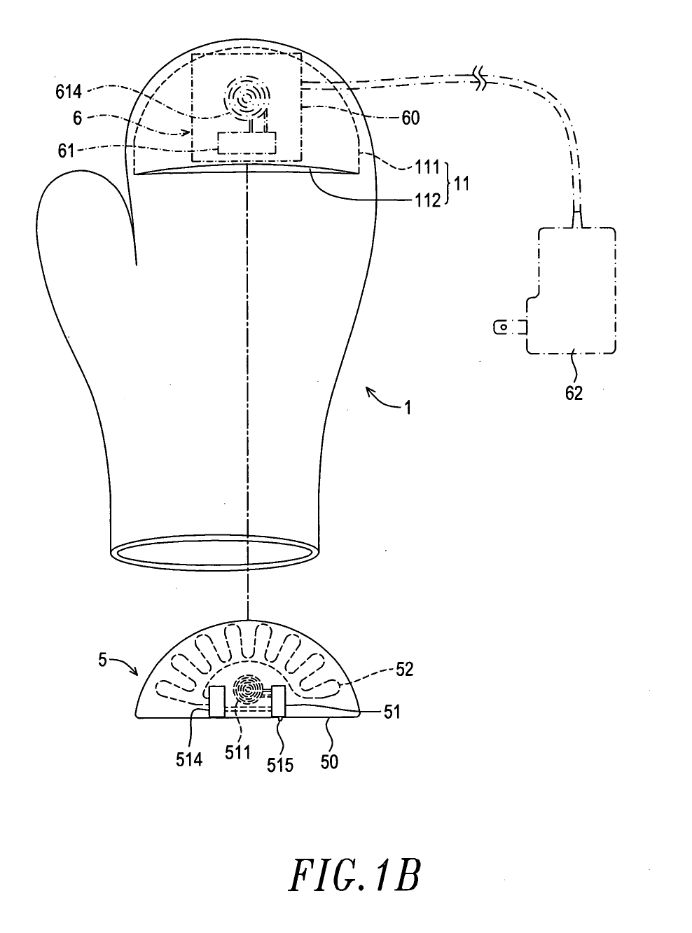

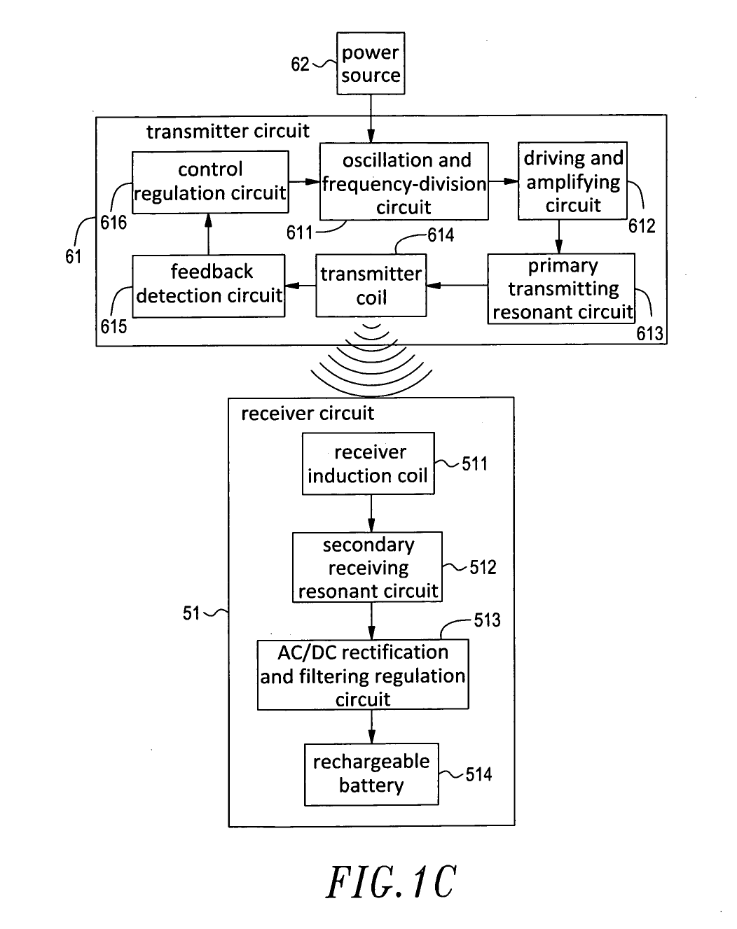

Referring to FIGS. 1A and 1B, a first embodiment according to the present invention is applied to a glove. The wirelessly-chargeable heating pad 5 receives electrical power through wireless electrical charging performed by the charging device 6 in order to power a heating element 52 to give off heat and thus realize the functions of temperature keeping and warm keeping.

The wirelessly-chargeable heating pad 5 comprises a pad body 50 and a receiver circuit 51 and a heating element 52, both of which are mounted on the pad body 50. The receiver circuit 51 comprises a rechargeable battery 514. The rechargeable battery 514 is electrically connected to the heating element 52 to supply electrical power to the receiver circuit 51 for giving off heat.

The article 1 comprises a removable mounting structure 11. In the third embodiment, the article 1 comprises a glove and the removable mounting structure 11 comprises for example a pocket-like receptacle portion 111. The receptacle portion 111 is attached, as an inner layer, to an inside surface of the glove. The receptacle portion 111 comprises an opening 112. The wirelessly-chargeable heating pad 5 is disposed, through the opening 112, into the receptacle portion 111 of the glove. As such, the wirelessly-chargeable heating pad 5 is coupled to the glove in a removable fashion and the removable mounting structure 11 allows a user to readily remove and mount the pad like wirelessly-chargeable heating pad 5.

The charging device 6 comprises a body 60 that contains therein a transmitter circuit 61, which is electrically connected to a power source 62. The power source 62 is pluggable into a power socket 7 to receive alternate current therefrom. The transmitter circuit 61 transmits the alternate current signal in a wireless fashion to the receiver circuit 51, and the receiver circuit 51 receives and converts the alternate current signal into electrical power. The electrical power so obtained through the conversion is supplied to and stored in the rechargeable battery 514 for subsequent supply to the heating element 52.

In use, the rechargeable battery 514 supplies electrical power to the heating element 52 for generating heat. When a user puts on the glove, the heat generated by the heating element 52 transmits through the cotton material of an inner layer to provide temperature-keeping and warm-keeping functions to the user's hand.

Referring to FIG. 1C, which is a circuit block diagram of the present invention, the circuit is common to all the embodiments, including first, second, and third embodiments, of the present invention.

The transmitter circuit 61 of the charging device 6 comprises an oscillation and frequency-division circuit 611, a driving and amplifying circuit 612, a primary transmitting resonant circuit 613, and a transmitter coil 614, which are electrically connected together, and preferably further comprises a feedback detection circuit 615 and a control regulation circuit 616, which are electrically connected to the oscillation and frequency-division circuit 611, the driving and amplifying circuit 612, the primary transmitting resonant circuit 613, and the transmitter coil 614.

The power source 62 that supplies electrical power is electrically connected to the oscillation and frequency-division circuit 611, so that the oscillation and frequency-division circuit 611 converts the electrical power into an alternate current signal. The driving and amplifying circuit 612 is electrically connected to the oscillation and frequency-division circuit 611 and serves to amplify the alternate current signal obtained through the conversion operation of the oscillation and frequency-division circuit 611. The primary transmitting resonant circuit 613 is electrically connected to the driving and amplifying circuit 612, and primary transmitting resonant circuit 613 subjects the amplified alternate current signal to resonance. The transmitter coil 614 is electrically connected to the primary transmitting resonant circuit 613, and the transmitter coil 614 transmits the alternate current signal that is subjected to resonance to the receiver circuit 51. The feedback detection circuit 615 is electrically connected to the transmitter coil 614. The control regulation circuit 616 is electrically connected between the oscillation and frequency-division circuit 611 and the feedback detection circuit 615. The feedback detection circuit 615 feeds the alternate current signal transmitted by the transmitter coil 614 back to the control regulation circuit 616 to allow the control regulation circuit 616 to regulate the oscillation frequency of the oscillation and frequency-division circuit 611.

The receiver circuit 51 comprises a receiver induction coil 511, a secondary receiving resonant circuit 512, and an AC/DC rectification and filtering regulation circuit 513.

The receiver induction coil 511 receives the alternate current signal transmitted from the transmitter circuit 61. The secondary receiving resonant circuit 512 is electrically connected to the receiver induction coil 511 and the alternate current signal is subjected to resonance by the secondary receiving resonant circuit 512. The AC/DC rectification and filtering regulation circuit 513 is electrically connected to the secondary receiving resonant circuit 512 and the AC/DC rectification and filtering regulation circuit 513 subjects the alternate current signal that is subjected to resonance to rectification and regulation for conversion into electrical power. The rechargeable battery 514 is electrically connected to the AC/DC rectification and filtering regulation circuit 513 and the rechargeable battery 514 stores the electrical power obtained through the conversion operation of the AC/DC rectification and filtering regulation circuit 513.

### Second Embodiment

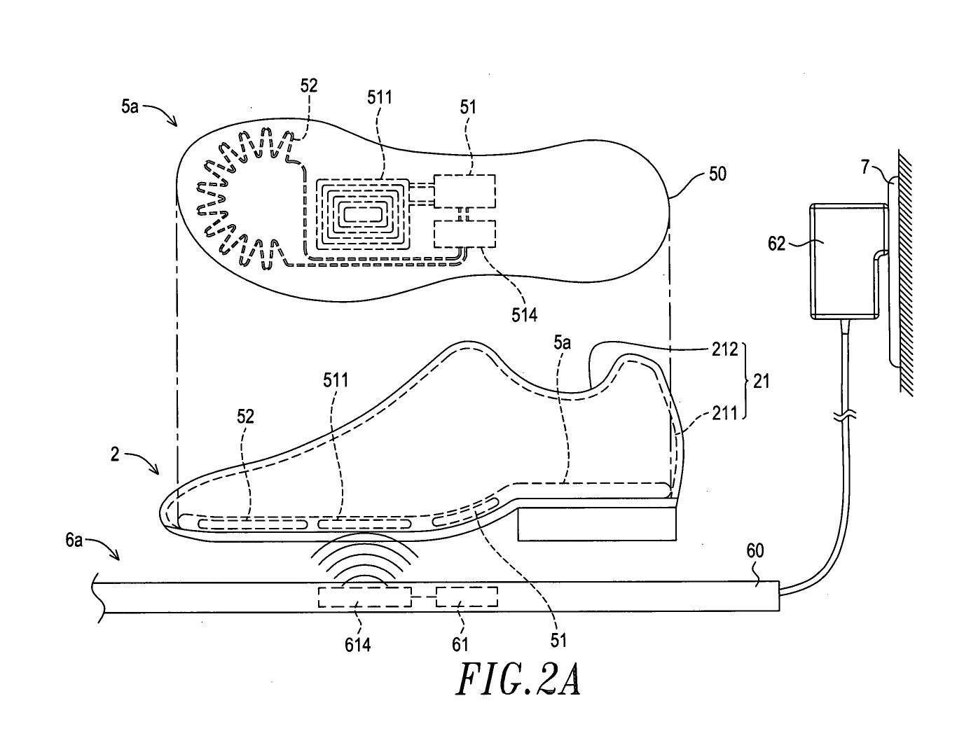

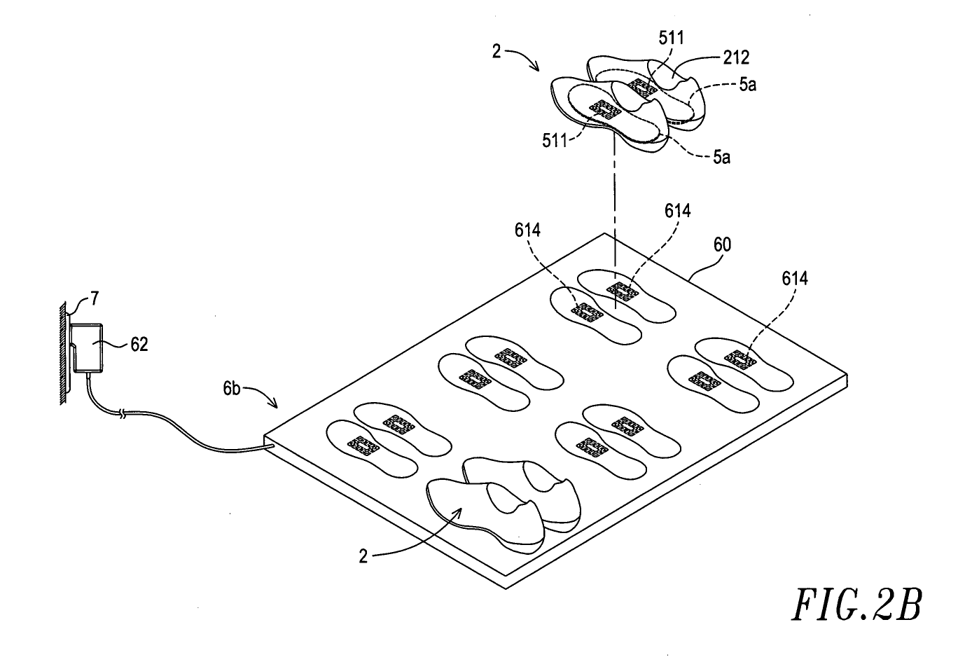

Referring to FIGS. 2A, 2B, and 2C, a wirelessly-chargeable heating pad according to a second embodiment of the present invention is shown. The wirelessly-chargeable heating pad 5a according to the second embodiment of the present invention and the circuit block diagram thereof are substantially identical to that of the first embodiment, except that shape of the wirelessly-chargeable heating pad 5a and the article 2 to which the present invention is applied are different from the first embodiment.

The article 2 comprises a removable mounting structure 21. In the second embodiment, the article 2 comprises footwear, such as a leather shoe, a sports shoe, or a leisure shoe. The wirelessly-chargeable heating pad 5a serves as a shoe pad, which can be a separately sold shoe pad to be additionally mounted inside the shoe. The pad body 50 comprises the receiver circuit 51 and the heating element 52. The removable mounting structure 21 comprises a receptacle portion 211 that receives a foot of a user and the receptacle portion 211 comprises an opening 212 through which the foot is inserted. The shoe pad (namely the wirelessly-chargeable heating pad 5a) is disposed, through the opening 212, into the receptacle portion 211 of the shoe (namely the article 2).

As shown in FIG. 2A, the charging device 6a comprises a foot mat and the body 60 of the charging device 6a contains the transmitter circuit 61 and the power source 62 therein. In use, the foot mat uses the power source 62 to receive an alternate current. The transmitter circuit 61 then transmits the alternate current signal in a wireless fashion. When a user treads the shoe on a corresponding location of the foot mat, the transmitter circuit 61 uses the transmitter coil 614 to transmit the alternate current signal, which will be then received by the receiver circuit 51 through the receiver induction coil 511 for electrically charging the rechargeable battery 514. The rechargeable battery 514 supplies the electrical power to the heating element 52 to generate heat. When the user puts on the shoe, the heat generated by the heating element 52 is transmitted through the shoe pad to achieve the functions of temperature keeping, warm keeping, and dry keeping for the foot.

As shown in FIG. 2B, the charging device 6b is shoe mat and the body 60 of the charging device 6b contains a plurality of transmitter circuits 61 (only a plurality of transmitter coils 614 being shown in the drawings, but the transmitter circuits 61 themselves being not shown) and a power source 62. The transmitter circuits 61 are commonly and electrically connected to the power source 62. In use, the shoe mat uses the power source 62 to receive an alternate current to allow the plurality of transmitter circuits 61 to transmit the alternate current signal in a wireless fashion. When a user positions the shoe on a predetermined location of the shoe mat, the corresponding transmitter circuit 61 uses the respective transmitter coil 614 to transmit the alternate current signal, which will be then received by the receiver circuit 51 through the receiver induction coil 511 for electrically charging the rechargeable battery 514.

### Third Embodiment

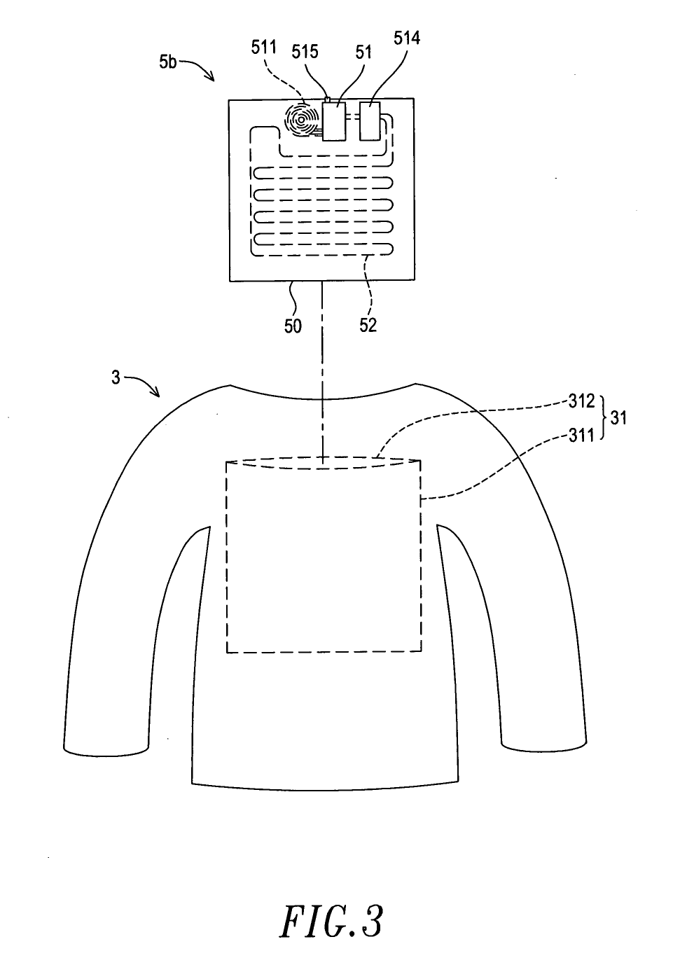

Referring to FIGS. 3 and 1C, a wirelessly-chargeable heating pad according to a third embodiment of the present invention is shown applied to a garment. The wirelessly-chargeable heating pad 5b according to the third embodiment of the present invention and the circuit block diagram thereof are substantially identical to that of the first embodiment, except that shape of the wirelessly-chargeable heating pad 5a and the article 3, to which the present invention is applied, are different from the first embodiment.

The article 3 comprises a removable mounting structure 31. In the third embodiment, the article 3 comprises a garment and the removable mounting structure 31 comprises for example a pocket-like receptacle portion 311. The receptacle portion 311 is attached, as an inner layer, to an inside surface of the garment. The receptacle portion 211 comprises an opening 312. The wirelessly-chargeable heating pad 5b is disposed, through the opening 312, into the receptacle portion 311 of the garment. As such, the wirelessly-chargeable heating pad 5b is coupled to the garment in a removable fashion and the removable mounting structure 31 allows a user to readily remove and mount the pad like wirelessly-chargeable heating pad 5b.

In use, the removable mounting structure 31 allows the wirelessly-chargeable heating pad 5b to be coupled to the garment in a removable fashion, whereby the heat generated by the heating element 52 can be dissipated to achieve temperature keeping and warm keeping functions for a user wearing the garment. To perform electrical charging (the charging device being omitted in FIG. 3), the charging device 6 shown in FIG. 1A is positioned to correspond to the wirelessly-chargeable heating pad 5b and then wireless electrical charging to the rechargeable battery 514 can be carried out in a non-contact fashion.

In the first and third embodiments discussed above, the body 60 of the charging device 6 may be provided with a clamp (not shown) for clamping the glove or garment thereby attaching the charging device 6 to a corresponding location on the glove or garment. Further, the receiver circuit 51 of the first or third embodiment may further comprise a switch 515, which controls the supply of electrical power from the rechargeable battery 514 to be ON or OFF. Besides the applications on gloves, shoes, and clothes, the wirelessly-chargeable heating pad according to the present invention can also be applied to pillows, medical heating pads, hats, chair cushions, and mattresses.

The features of the wirelessly-chargeable heating pad according to the present invention are as follows:

(1) Flexibility and convenience of electrical charging can be ensured through the non-contact wireless electrical charging.

(2) Functions of temperature keeping, warm keeping, and dry keeping (especially keeping foot dry) can be achieved on human body wearing the an article of for example glove, shoe, and garment, to which the wirelessly-chargeable heating pad of the present invention is coupled.

(3) The arrangement of the removable mounting structure 11, 21, 31 allows the wirelessly-chargeable heating pad 5, 5a, 5b to be readily removed and ensures easy repairing and maintenance of the wirelessly-chargeable heating pad (for the removed wirelessly-chargeable heating pad), and also allows the article 1, 2, 3 to be water-washable without concern any problem of short-circuiting and malfunctioning of the wirelessly-chargeable heating pad caused by water washing.

(4) The rechargeable battery 514 can be the recently developed sheet like flexible battery, which allows the article to be easily put on a user's body.

(5) When the wirelessly-chargeable heating pad functions as a shoe pad, (a) since the pad is in direct contact with a user's foot, improved thermal efficiency can be achieved; (b) with the receiver circuit 51 being properly protected through insulation protection, the shoe pad can be removed for washing to thereby ensure cleanliness of the shoe pad; (c) the shoe and the shoe pad can be manufactured separately to allow a user to readily replace a new shoe pad; (d) the user may purchase only one shoe pad, but uses the shoe pad in many shoes; (e) the pad can be made according to the foot shape of a user; (f) the shoe pad can be adjusted according to different purposes of use or various conditions of road.

(6) The wirelessly-chargeable heating pad according to the present invention can be used as a heating bag to position flat between two overlapped garments and can also be received in a pocket of a shirt, pants, or a skirt in the same way as a heating bag to achieve such a convenience for ready use and carrying anywhere and due to the function of wireless recharging, there is no need to repeatedly purchase so as to ensure environmental protection.

(7) The wirelessly-chargeable heating pad according to the present invention can be further provided with a waterproof structure (such as a waterproof layer or waterproof resin) to ensure use safety against electrical leaking.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A wirelessly-chargeable heating pad, which is adapted to be coupled to an article and is used in combination with a charging device that comprises a transmitter circuit, the transmitter circuit being connected to a power source, the power source supplying electrical power to the transmitter circuit, the electrical power being converted by the transmitter circuit into an alternate current signal, the wirelessly-chargeable heating pad comprising:
a receiver circuit, which comprises a rechargeable battery;
a heating element, which is electrically connected to the rechargeable battery; and
a pad body, on which the heating element and the receiver circuit are mounted;
wherein the article comprises a removable mounting structure, the pad body that contains the heating element and the receiver circuit is removably coupleable to the article through the removable mounting structure, the transmitter circuit of the charging device transmitting the alternate current signal to the receiver circuit, the receiver circuit receiving and converting the alternate current signal into electrical power to be stored in the rechargeable battery for being subsequently supplied to the heating element.

2. The wirelessly-chargeable heating pad as claimed in claim 1, wherein the removable mounting structure comprises a receptacle portion that is mounted to the article, the receptacle portion having an opening through which the wirelessly-chargeable heating pad is received into the receptacle portion.

3. The wirelessly-chargeable heating pad as claimed in claim 1, wherein the article comprises a garment and the removable mounting structure is mounted to the garment, the removable mounting structure comprising a receptacle portion that has an opening, the wirelessly-chargeable heating pad being received through the opening into the receptacle portion of the garment.

4. The wirelessly-chargeable heating pad as claimed in claim 1, wherein the article comprises a glove and the removable mounting structure is mounted to the glove, the removable mounting structure comprising a receptacle portion that has an opening, the wirelessly-chargeable heating pad being received through the opening into the receptacle portion of the glove

5. The wirelessly-chargeable heating pad as claimed in claim 1, wherein the pad body is a shoe pad and the article comprises a shoe, the removable mounting structure being formed in the shoe, the removable mounting structure comprising a receptacle portion that receives a foot of a user, the receptacle portion having an opening for insertion of the foot, the shoe pad being received through the opening into the receptacle portion inside the shoe.

6. The wirelessly-chargeable heating pad as claimed in claim 5, wherein the charging device comprises a foot mat that contains therein the transmitter circuit, the transmitter circuit being electrically connected to the power source.

7. The wirelessly-chargeable heating pad as claimed in claim 5, wherein the charging device comprises a shoe mat that contains therein a plurality of transmitter circuits, which are commonly and electrically connected to the power source.

8. The wirelessly-chargeable heating pad as claimed in claim 1, wherein the charging device comprises a body that contains therein the transmitter circuit, the transmitter circuit being electrically connected to the power source.

9. The wirelessly-chargeable heating pad as claimed in claim 1, wherein the transmitter circuit of the charging device comprises an oscillation and frequency-division circuit, a driving and amplifying circuit, a primary transmitting resonant circuit, and a transmitter coil, which are electrically connected together, wherein:
the power source that supplies electrical power is electrically connected to the oscillation and frequency-division circuit, so that the oscillation and frequency-division circuit converts the electrical power into an alternate current signal; the driving and amplifying circuit is electrically connected to the oscillation and frequency-division circuit and serves to amplify the alternate current signal obtained through the conversion operation of the oscillation and frequency-division circuit; the primary transmitting resonant circuit is electrically connected to the driving and amplifying circuit and subjects the amplified alternate current signal to resonance; and the transmitter coil is electrically connected to the primary transmitting resonant circuit and transmits the alternate current signal that is subjected to resonance to the receiver circuit.

10. The wirelessly-chargeable heating pad as claimed in claim 9, wherein the transmitter circuit of the charging device further comprises a feedback detection circuit and a control regulation circuit, which are electrically connected to the oscillation and frequency-division circuit, the driving and amplifying circuit, the primary transmitting resonant circuit, and the transmitter coil, wherein
the feedback detection circuit is electrically connected to the transmitter coil; the control regulation circuit is electrically connected between the oscillation and frequency-division circuit, the feedback detection circuit being also electrically connected to the control regulation circuit; the feedback detection circuit feeds the alternate current signal transmitted by the transmitter coil back to the control regulation circuit to allow the control regulation circuit to regulate the oscillation frequency of the oscillation and frequency-division circuit.

11. The wirelessly-chargeable heating pad as claimed in claim 1, wherein the receiver circuit comprises a receiver induction coil, a secondary receiving resonant circuit, and an AC/DC rectification and filtering regulation circuit, wherein:
the receiver induction coil receives the alternate current signal transmitted from the transmitter circuit; the secondary receiving resonant circuit is electrically connected to the receiver induction coil and the alternate current signal is subjected to resonance by the secondary receiving resonant circuit; the AC/DC rectification and filtering regulation circuit is electrically connected to the secondary receiving resonant circuit and the AC/DC rectification and filtering regulation circuit subjects the alternate current signal that is subjected to resonance to rectification and regulation for conversion into electrical power; and the rechargeable battery is electrically connected to the AC/DC rectification and filtering regulation circuit and stores the electrical power obtained through the conversion operation of the AC/DC rectification and filtering regulation circuit.

12. The wirelessly-chargeable heating pad as claimed in claim 1 or 11, wherein the receiver circuit comprises a switch, which controls supply of electrical power from the rechargeable battery to be ON or OFF.
